(19) United States
(12) Patent Application Publication
(10) Pub. No.: US 2022/0267181 A1
(43) Pub. Date: Aug. 25, 2022

(54) Fluorescent-Tagged Treatment Polymers

(71) Applicants: Dow Global Technologies LLC, Midland, MI (US); Rohm and Haas Company, Collegeville, PA (US)

(72) Inventors: Kaylie L. Young, Sugar Land, TX (US); Robert D. Grigg, Midland, MI (US); Graham P. Abramo, Penllyn, PA (US); Matthew S. Remy, Midland, MI (US); Eric Wasserman, Collegeville, PA (US)

(21) Appl. No.: 17/597,843

(22) PCT Filed: Nov. 2, 2020
(86) PCT No.: PCT/US2020/058520

§ 371 Date: Jan. 26, 2022

Related U.S. Application Data
(60) Provisional application No. 62/932,044, filed on Nov. 7, 2019.
(60) Provisional application No. 62/932,085, filed on Nov. 7, 2019.

(51) Int. Cl. C02F 5/14; C02F 1/00

(52) U.S. Cl. CPC C02F 5/14; C02F 1/008; C02F 2103/023

(57) ABSTRACT

Embodiments relate a method of treating a water system that includes providing to the water system a fluorescent-tagged treatment polymer that is the reaction product of a mixture that includes at least one unsaturated monomer, at least one initiator with at least one reactive terminal group for reacting with the unsaturated monomer, and at least one fluorescent chain transfer agent, the at least one fluorescent chain transfer agent having a phosphorus-hydrogen or sulfur-hydrogen group connected to a polyaromatic hydrocarbon group having from two to ten rings, and the at least one fluorescent chain transfer agent being a chain transfer agent that controls final polymer molecular weight of the fluorescent-tagged treatment polymer and a fluorescent tag for the fluorescent-tagged treatment polymer.

### FIELD

Embodiments relate to fluorescent-tagged treatment polymers, a method of making fluorescent-tagged treatment polymers, and a method of using fluorescent-tagged treatment polymers in water systems.

### Introduction

Various methods have been adopted to reduce the amount of water used in industrial water systems such as cooling water systems and boiler water systems. However, such methods may lead to unfavorable events such as corrosion and/or the formation of scale as the quality of the water in the system progressively deteriorates. As such, the use of polymeric treatment agents in such water systems has been proposed. The treatment agent may be used at specific concentrations in the water system, which concentrations are an important factor for performance of the desired function with good efficiency. However, during operation the treatment polymer may be consumed by various causes, such that the concentration may not remain consistent. With consumption, the amount of the treatment polymer dissolved in the cooling water does not remain the same as the amount added to the cooling water. Therefore, practical methods to determine the concentration of treatment polymers in the industrial water systems are sought.

The use of fluorescent polymers prepared with reactive fluorescent compounds is proposed for monitoring concentrations of treatment agents in industrial water systems in International Publication Nos. WO 2019/027608 and WO 2019/027611. Further, methods for maintaining the desired amount of such fluorescent polymers in industrial water systems are proposed in International Publication Nos. WO 2019/027609 and WO 2019/027610. However, further cost advantaged fluorescent polymers are sought for use in monitoring concentrations of treatment agents.

### SUMMARY

Embodiments may be realized by a method of treating a water system that includes providing to the water system a fluorescent-tagged treatment polymer that is the reaction product of a mixture that includes at least one unsaturated monomer, at least one initiator with at least one reactive terminal group for reacting with the unsaturated monomer, and at least one fluorescent chain transfer agent. The at least one fluorescent chain transfer agent has a phosphorus-hydrogen or sulfur-hydrogen group connected to a polyaromatic hydrocarbon group having from two to ten rings. The at least one fluorescent chain transfer agent is a chain transfer agent that controls final polymer molecular weight of the fluorescent-tagged treatment polymer and a fluorescent tag for the fluorescent-tagged treatment polymer.

### BRIEF DESCRIPTION OF THE DRAWINGS

Features of the embodiments will become more apparent to those of ordinary skill in the art by describing in detail exemplary embodiments thereof with reference to the attached drawings in which:

FIG. 1 illustrates emission data for Example 3 and Comparative Example D; and

FIG. 2 illustrates a quantification of concentration and emission response for Example 3.

### DETAILED DESCRIPTION

The fluorescent polymers may be used as an fluorescent tracer that is added to water systems such as industrial water systems. The water systems may be cooling water systems and/or boiler water systems. During use the amount of the fluorescent tracer present correlates with the amount of a specific treatment polymer present. For example, the fluorescent tracer and the treatment polymer may be added to the water system in known proportions and the measured amount of fluorescent tracer present is correlated with the amount of treatment polymer present. According to exemplary embodiments, the treatment agent is tagged with a reactive fluorescent compound. A fluorimeter may be used to measure the fluorescence signal of the fluorescent tracer and the amount of the fluorescent tracer can be determined by using a calibration curve to relate the amount of fluorescence signal detected to the amount of the fluorescent tracer present. Monitoring of the fluorescent tracer can be conducted on-line in real time so that any changes in the amount of treatment polymer can determined.

When the polymeric treatment agent is tagged with the fluorescent tracer, the amount of the fluorescent compound incorporated should be sufficient enough such that the fluorescence of the polymer may be adequately measured. For example, fluorescently-tagged treatment polymer may be detectable by fluorimetric techniques known in the industry. Further, it should not be so high that the performance of the polymer as a treatment agent for the water is decreased. Also, when the treatment agent is tagged, a better quantification is possible as the measure of consumption of the treatment agent and possible occurrence of a non-desired event associated with the treatment agent, such as scaling when using a scale inhibitor treatment agent. However, fluorescent tagging of polymers may be difficult and costly to accomplish because of the difficulty in chemically combining fluorescent moieties with non-fluorescent polymers and the cost of components and processing. As such, to synthesize tagged treatment polymers it is desirable to provide reactive fluorescent compounds that are readily incorporated into treatment polymers to form tagged treatment polymers.

Embodiments relate to use of fluorescent chain transfer agents to form a fluorescent tagged treatment polymer. The fluorescent moiety of the fluorescent chain-transfer agent attaches to (i.e., forms covalent bonds with) the treatment polymer as a chain transfer agent during polymeric synthesis of the treatment polymer. The fluorescent chain transfer agent acts as both (i) an agent that terminates further polymerization on the polymeric molecule in a reaction mixture used to make the polymeric molecule, and (ii) a fluorescent tag on the treatment polymer (e.g., a terminal tag). As such, the fluorescent chain transfer agent controls final polymer molecular weight for the treatment polymer and is a fluorescent tag for a treatment polymer. In this regard, the fluorescent chain transfer agents are both chain transfer agents during polymer growth such that they control final molecular weight and are tags in the finally formed fluorescent-tagged treatment polymer.

In the process of preparing the tagged treatment polymer, fluorescent organic molecules covalently bond to a group (e.g., to a phosphorus-hydrogen or sulfur-hydrogen group) that is capable of participating in the radical chain transfer mechanism in order to introduce a fluorescent moiety into the treatment polymer. This differs from previous approaches in that the fluorescent moiety is introduced during polymerization of the treatment agent polymer itself and is not introduced as a sole monomer or post-polymerization. The fluorescent chain transfer agent may remain incorporated with the treatment polymer, e.g., no further processing may be performed to have the polymer chain transferred to another molecule. Accordingly, use of the fluorescent chain transfer agent is cost advantaged, as the fluorescent moiety may be introduced during the polymerization process, and does not require additional processing.

The fluorescent chain transfer agent may be soluble in a polymerization solvent used to make the treatment polymer. The fluorophore may be stable under the free radical polymerization conditions. The fluorescent chain transfer agent may be added as a salt during the polymerization process of the treatment polymer

Embodiments relate to use of fluorescent chain transfer agents with a phosphorus-hydrogen or sulfur-hydrogen group connected to a polyaromatic hydrocarbon group (fluorophore) with two to ten rings (such as two to eight rings, two to five rings, two to four rings, etc.) in the process of preparing tagged treatment polymers. Without intending to be bound by this theory, it is believed use of compounds with polyaromatic hydrocarbon group having greater than 10 rings may not be an effective chain transfer agent based on high molecular weight and/or interference from the polyaromatic group itself. The phosphorus-hydrogen or sulfur-hydrogen group may be indirectly or directly connected to the polyaromatic hydrocarbon group (e.g., with or without additional covalent bonds there between).

Fluorescent chain transfer agents having both the phosphorus-hydrogen or sulfur-hydrogen group connected to a polyaromatic hydrocarbon group may act as a good chain transfer agent during polymerization of the tagged treatment polymer such that a desirable PDI is obtained for the polymeric product. Further, the fluorescent chain transfer agent may be sufficiently fluorescent to enable detection at an adequate level for the intended use as a tagged treatment polymer in water systems. Also, the fluorescent chain transfer agent may be sufficiently stable to allow for a good correlation as a measure of consumption/scaling when using the tagged treatment agent in a water system.

Exemplary fluorescent chain transfer agents having the phosphorus-hydrogen or sulfur-hydrogen group connected to a polyaromatic hydrocarbon group include phosphinic based compounds having at least one polyaromatic hydrocarbon group and/or thiol based compounds having at least one polyaromatic hydrocarbon group. By phosphinic based compound it is meant at least one phosphinic group is present, i.e., a PO₂H₂ or the anion PO₂H. The phosphinic group may be derived from phosphinic acid. By thiol based compound it is meant at least one thiol group it is meant an organosulfur compound having at least one S—H group. By polyaromatic hydrocarbon group it is meant that at least two aromatic hydrocarbon rings are present. Each ring in the polyaromatic hydrocarbon group is unsaturated, with at least one carbon-carbon double bond. The at least two aromatic hydrocarbon rings in the polyaromatic hydrocarbon group may be present in an amount from 2 to 10 (e.g., 2 to 7, 2 to 5, 2 to 4, etc.). The at least two aromatic hydrocarbon ring structures may be interconnected (fused), e.g., may be 2, 3, 4, or 5 interconnected aromatic hydrocarbon rings. The polyaromatic hydrocarbon group may be a naphthalene group, an anthracene group, a triphenylene group, a pyrene group, a phenanthrene group, and/or a chrysene group. For example, the polyaromatic hydrocarbon group may be a naphthalene group, a anthracene group, and/or a pyrene group. The polyaromatic hydrocarbon group may be interconnected (fused) with a heterocyclic group, such as a nitrogen or oxygen containing hetrocyclic group. The polyaromatic hydrocarbon group may be directly or indirectly bonded to the phosphinic group and/or thiol group.

Exemplary phosphinic based compounds include the following:

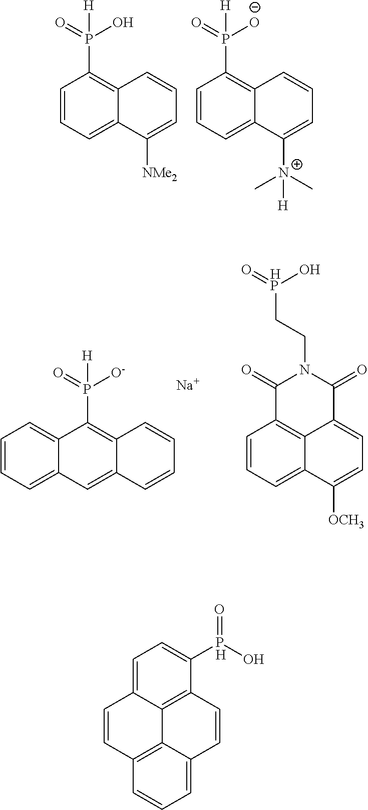

According to exemplary embodiments, thiol based compounds include the following:

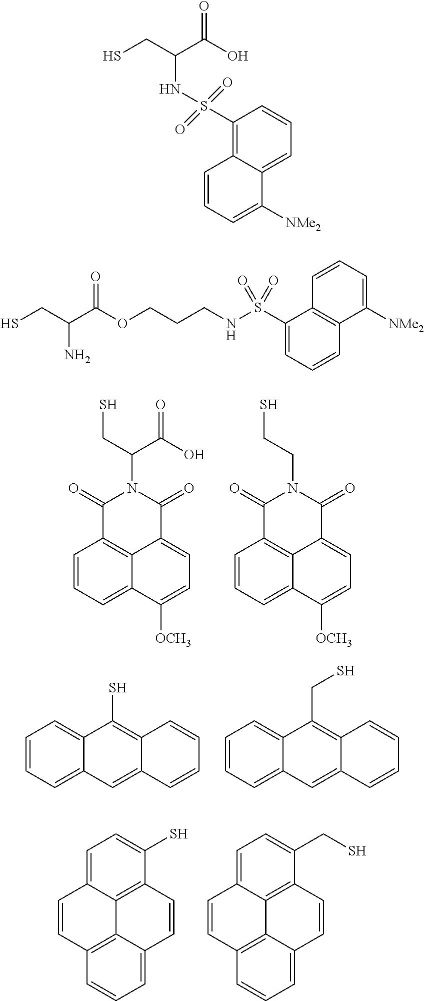

As would be understood by a person of ordinary skill in the art, the above includes isomers of those formulas and the formulas in ionic (charged) form. Further, a combination of the above may be used as the fluorescent chain transfer agents.

The fluorescent-tagged treatment polymers may be prepared by a polymerization process that is conducted as batch, semi-continuous, or continuous process. The fluorescent-tagged treatment polymer may be the reaction product of a mixture that includes at least monomer(s), initiator(s), and fluorescent chain transfer agent(s) as reactive components, such that the fluorescent tag of the treatment polymer is formed in situ during polymerization of the treatment polymer. The reactive components for forming the tagged treatment polymers may be fed to the reactor individually, co-fed (as a mixture), or combinations thereof. For example, polymerization of the tagged treatment polymer may be conducted as a process in which substantially all of the unsaturated monomer(s) (such as monoethylenically unsaturated monomers), the initiator(s), and fluorescent chain transfer agent(s) are metered (“fed”) into a polymerization reactor. By monomer(s) it is meant that at least one unsaturated monomer may be used to prepare the fluorescent-tagged treatment polymer. By initiator(s) it is meant that at least one initiator may be used to prepare the fluorescent-tagged treatment polymer. By fluorescent chain transfer agent(s) it is that at least one fluorescent chain transfer agent may be used to prepare the fluorescent-tagged treatment polymer.

The monomer(s), initiator(s), and fluorescent chain transfer agent(s) may be introduced into the reaction mixture as combined and/or separate streams fed at independent feed rates. The streams may be staggered so that one or more of the streams are completed before the others. The feeds may conducted as times as needed to form the fluorescent tagged polymer, such as from 5 minutes to 5 hours (e.g. 30 minutes to 4 hours, 1 hour to 3 hours, etc.).

When the polymerization process is run as a heel process, a portion of the unsaturated monomer(s), initiator(s), and/or fluorescent chain transfer agent(s), may be initially added to the reactor. The remainder of any of these reactive components may then be fed into the reactor in the same manner as described above.

The polymerization reaction may be conducted at an elevated temperature (optionally elevated pressure), which temperature may depend on the choice of initiator(s) and/or target molecular weight. For example, the temperature of the polymerization may be 25° C. to 110° C. (e.g., 40° C. to 105° C.). The polymerization process may be an aqueous processes, which may optionally be substantially free of organic solvents. The water may be introduced into the reaction mixture as a separate feed, as the solvent for one or more of the other components of the reaction mixture, or some combination thereof. The polymerization process may result in a product with a final solids levels in the range from 20 wt % to 100 wt %, based on a total weight of the resultant product.

Exemplary monomer(s) for preparing the tagged treatment polymer unsaturated monomers (e.g., monoethylenically unsaturated monomer(s)). At least one unsaturated monomer(s) has an unsaturated group. The unsaturated group may be a terminal group on the monomer. The unsaturated monomer(s) may further include one to five carbonyl groups (e.g., one to two carbonyl groups). Exemplary unsaturated monomers include acrylic acid, methacrylic acid, acrylamide, 4-vinyl phenol, maleic acid, itaconic acid, 2-acrylamido-2-methylpropane sulfonic acid, t-butyl acrylamide, and derivatives thereof. The unsaturated monomer(s) may have a molecular weight that is from 50 g/mol to 500 g/mol.

The monomer(s) may be highly acidic (e.g., a pH of 4 or below). The pH of the solution that includes the monomer(s) may be controlled by a buffer system or by the addition of a suitable acid or base. The solution that includes the monomer(s) may be substantially free of any metal ions. The addition of metal ions to the polymerizing monomer mixture may add to the cost of the process, may necessitate a separation or purification step, may discolor the product, and introduces contaminants.

Exemplary initiator(s) for preparing the tagged treatment polymer include peroxide, sulfite, persulfate, azo compounds, and derivatives thereof. The initiators may be in the form of derivatives that are salts of the peroxides, sulfites, persulfates, and/or azo compounds. The initiator may form the base chain of the treatment polymer during the polymerization process in which the monomers are added to the initiator (e.g., the initiator initiates polymer growth to form the treatment polymer). The initiator(s) have at least one reactive terminal group that is capable of reacting with the unsaturated monomer (e.g., the unsaturated group carbon-carbon double bond of the monomer) to initiate monomeric addition of the unsaturated monomer onto the initiator to form the treatment polymer. Examples of an initiator include sodium persulfate and 2,2′-Azobis(2-methylpropionamidine) dihydrochloride. The initiator(s) may be used in an amount from 1% to 50% of a total weight of the monomer(s) present. The initiator(s) may have a number average molecular weight that is from 50 g/mol to 500 g/mol.

The process typically results in good conversion of the monomer(s) and initiator(s) into the tagged treatment polymer product, in which the fluorescent chain transfer agent is used both to control polymer molecular weight and add a fluorescent tag on the polymer. The process may exclude the use of additional chain transfer agents, other than the fluorescent chain transfer agents. If residual monomer levels in the resultant product are undesirably high, it may be reduced by use of an additive(s) such as reducing agent(s) or various other process, as would be understood by a person skilled in the art.

The tagged treatment polymers may be water-soluble, so as to be adaptable for use in water system. As water-solubility may be affected by the molecular weight of the tagged treatment polymer, it is desirable to control the resultant molecular weight to allow for useable water solubility. The tagged treatment polymer may have a weight average molecular weight from 200 g/mol to 50,000 g/mol (e.g., from 500 to 25,000, from 1,000 to 20,000, from 2,000 to 15,000, from 3,000 to 14,000, etc.) The tagged treatment polymer may have a number average molecular weight from 200 g/mol to 20,000 g/mol (e.g., from 500 to 15,000, from 1,000 to 10,000, from 1,000 to 8,000, etc.) The tagged treatment polymer may have a PDI (polydispersity, Mw/Mn) greater than 1 and less than 4. For example, the PDI may be from 2 to 3.

The amount of reactive fluorescent compound in the fluorescently-tagged treatment polymer should be an amount sufficient to allow the (co)polymer to be detected in the aqueous environment that it is used. The minimum amount of fluorescent moiety may be that which gives a signal-to-noise ratio (S/N) of 3 at the desired treatment polymer dosage. The signal-to-noise ratio is that value where the magnitude of the transduced signal (such as electronic and/or optical signals) based on the presence of a target analyte in a measurement device is greater than or equal to a level three (3) times the magnitude of a transduced signal where the analyte (species) of interest is not present in the measurement device. For example, the amount may be from 0.01 wt % to 10.00 wt % (e.g., from 0.1 wt % to 5.0 wt %, from 1 wt % to 3 wt %, etc.) based on the total weight of the fluorescently-tagged treatment polymer.

According to exemplary embodiments, the fluorescent-tagged treatment polymers may be used as scale inhibitors in any water system where a scale inhibitor is needed (such as industrial water systems). Exemplary water systems, include reverse osmosis systems, cooling tower water systems (including open recirculating, closed and once-through systems); petroleum wells, downhole formations, geothermal wells and other oil field applications; boilers and boiler water systems; thermal desalination systems, mineral process waters including mineral washing, flotation and benefaction; paper mill digesters, washers, bleach plants and white water systems; black liquor evaporators in the pulp industry; gas scrubbers and air washers; continuous casting processes in the metallurgical industry; air conditioning and refrigeration systems; industrial and petroleum process water; indirect contact cooling and heating water, such as pasteurization water; water reclamation and purification systems; membrane filtration water systems; food processing streams (meat, vegetable, sugar beets, sugar cane, grain, poultry, fruit and soybean); and waste treatment systems as well as in clarifiers, liquid-solid applications, municipal sewage treatment and industrial or municipal water systems.

When the fluorescent-tagged treatment polymers are used as scale inhibitors, they may be consumed while performing that function, which should result in a decrease of the fluorescent signal, which decrease in the fluorescent signal may be used to indicate that undesired scaling is taking place. The fluorescent-tagged treatment polymer may be used in water systems as the sole treatment polymer and/or in combination with other treatment polymers (tagged or non-tagged)

The fluorescent-tagged treatment polymer may be used in a water system in an amount from 0.1 milligrams (mg) to 100 milligrams of the total solid polymer actives per liter of water in the system. This is equivalent to 0.1 part per million (hereinafter “ppm”) to 100 ppm.

When used in a water system, the fluorescent signal of the fluorescent-tagged treatment polymers can be used to determine how much of the treatment polymer is present according the following exemplary method for maintaining a desired amount of a fluorescent-treatment polymer in a water system, includes: (a) adding the fluorescent-tagged treatment polymer to water such that a desired concentration of such treatment polymer is present in the water; (b) using a fluorimeter to detect the fluorescence signal of the fluorescent-tagged treatment polymer (e.g., an online system or a hand held system); (c) converting the fluorescence signal to the concentration of the fluorescent-tagged treatment polymer present; and (d) adjusting the concentration of the fluorescent-tagged treatment polymer according to what the desired concentration is for the fluorescent-tagged treatment polymer in the water system.

In an exemplary embodiment, a method for maintaining a desired amount of fluorescent-tagged treatment polymer in a water system, includes: (a) adding an inert tracer and the fluorescent-tagged treatment polymer to water such that a desired concentration of such treatment polymer in is present in the water; (b) using a fluorimeter to detect the fluorescence signals of the inert tracer and the fluorescent-tagged treatment polymer (e.g., an online system or a hand held system); (c) converting the fluorescence signals to the concentration of the inert tracer and the fluorescent-tagged treatment polymer present; and (d) adjusting the concentration of the fluorescent-tagged treatment polymer according to what the desired concentration is for the fluorescent-tagged treatment polymer in the water system.

In an exemplary embodiment, a method for use of the fluorescent-tagged treatment polymer as a scale inhibitor in a water system, includes: (a) adding the fluorescent-tagged treatment polymer to water such that a desired concentration of the such treatment polymer is present in the water, whereas fluorescent-tagged treatment polymer is present in an amount from 0.1 ppm to 100 ppm per liter of water.

Prior to use in a water system, the fluorescent-tagged treatment polymer may be dialyzed. As it is possible that unreacted reagents (fluorescent and non-fluorescent) may be present after the polymerization reaction, a dialysis process may optionally be performed on the fluorescent-tagged treatment polymer to reduce/minimize the presence of unpolymerized, monomeric fluorophores, which are not covalently attached to the polymer.

### Examples

Approximate properties, characters, parameters, etc., are provided below with respect to the illustrative working examples, comparative examples, and the information used in the reported results for the working and comparative examples.

The materials principally used are the following:

| | |
|---|---|
| CTA 1 | A fluorescent chain transfer agent that is a |
| | anthracen-9-ylphosphinic acid sodium salt, |
| | prepared as discussed below. |
| CTA 2 | A fluorescent chain transfer agent that is a 5- |
| | (dimethylamino)napthalen-1-yl)phosphinic |
| | acid, prepared as discussed below. |
| CTA 3 | A non-fluorescent chain transfer agent that is |
| | sodium benzene phosphinic acid, which is |
| | available from Special Materials Company. |
| Initiator 1 | Sodium persulfate |
| Initiator 2 | Vazo™ 56, available from Chemours. |

### Preparation of Fluorescent Chain Transfer Agents

Synthesis of CTA 1, which is anthracen-9-ylphosphinic acid sodium salt

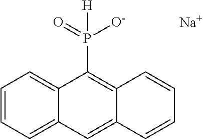 [SMILES: O=[PH]([O-])c1c2ccccc2cc2ccccc12 ; [Na+]]

A 500 mL round bottom flask is charged with 9-bromoanthracene (15.0 grams, 58.3 mmol, 1.00 equiv) and 150 mL dry tetrahydrofuran. The solution is placed under nitrogen and cooled to −78° C. Then, n-butyllithium (1.6 M in hexane, 38.3 mL, 61.2 mmol, 1.05 equiv) is added dropwise to the flask. The is mixture stirred at −78° C. for 30 minutes. Next, bis(diethylamino)chlorophosphine (13.5 mL, 64.1 mmol, 1.10 equiv) is injected. The mixture is allowed to warm to room temperature overnight. The solution is cooled to 0° C. and HCl (2.0 M in diethyl ether, 146 mL, 292 mmol, 5.00 equiv) is added. The slurry is stirred for 2 hours. The homogeneous solution gradually turned cloudy, yellow, and heterogeneous. Nitrogen-sparged water (74 mL, 4.1 mol, 70.0 equiv) is injected. The mixture is stirred for an additional 2 hours. The biphasic suspension is filtered to remove the solid yellow product. The solid is rinsed with 2×50 mL dichloromethane and dried in a vacuum oven to give 13.2 grams of solid is isolated (anthracen-9-ylphosphinic acid—94% yield). The solid is suspended in 150 mL methanol and sodium hydroxide (2.2 grams, 1.00 equiv) is added. The mixture is stirred for 1 hour, which dissolved the entire solid. Then, the pH is measured as approximately 7. Volatiles are removed by rotary evaporation and vacuum oven drying. Approximately, 15.5 grams of solid is isolated (anthracen-9-ylphosphinic acid sodium salt).

Characterization of the resultant CTA1 product is as follows:

¹H NMR (400 MHz, D₂O) δ 8.75 (d, J=9.0 Hz, 2H), 8.57 (d, J=535.0 Hz, 1H), 8.19 (s, 1H), 7.74 (d, J=8.5 Hz, 2H), 7.49 (ddd, J=8.6, 6.7, 1.5 Hz, 2H), 7.40-7.26 (m, 2H).

¹³C NMR (101 MHz, D₂O) δ 131.67 (d, J=8.9 Hz), 131.54 (d, J=3.3 Hz), 130.58 (d, J=10.7 Hz), 129.25, 127.69 (d, J=123.0 Hz), 126.85, 125.12, 124.64 (d, J=12.1 Hz).

³¹P NMR (162 MHz, D₂O) δ 13.64.

Synthesis of CTA 2 starts with making 5-bromo-N,N-dimethylnapthalen-1-amine, which as the following structure

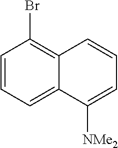 [SMILES: CN(C)c1cccc2c(Br)cccc12]

A 1 L round bottom flask is charged with 5-bromonapthalen-1-amine (25.3 grams, 113.9 mmol, 1.00 equiv) and 455 mL acetonitrile. Then, 37 wt % of aqueous formaldehyde (84.8 mL, 1.1 mol, 10 equiv) is added, followed by sodium cyanoborohydride (21.5 grams, 341.7 mmol, 3.0 equiv). The reaction mixture is cooled in an ice bath, and glacial acetic acid (11.4 mL) is added in portions over 45 minutes. The mixture is stirred for 1 hour, at which point, TLC showed complete consumption of starting material. The solution is diluted with dichloromethane (500 mL), and is washed with 1 M NaOH (3×300 mL). The organic phases are combined, concentrated and purified by chromatography on silica gel (0 to 20% EtOAc in hexane). Approximately 23.4 grams of product is isolated as a red oil (5-bromo-N,N-dimethylnapthalen-1-amine—82% yield).

Characterization of the resultant product is as follows:

¹H NMR (500 MHz, CDCl₃) δ 8.23 (d, J=8.5 Hz, 1H), 7.93 (d, J=8.5 Hz, 1H), 7.75 (d, J=7.4 Hz, 1H), 7.49 (t, J=8.4, 7.4 Hz, 1H), 7.38-7.26 (m, 1H), 7.12 (dt, J=7.5, 1.0 Hz, 1H), 2.87 (s, 6H).

¹³C NMR (126 MHz, CDCl₃) δ 151.21, 133.24, 130.22, 129.90, 127.12, 125.24, 124.16, 123.14, 121.83, 114.85, 45.34.

Synthesis of CTA 2 uses the product from above to make the following final structure

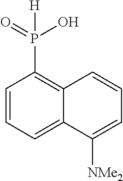 [SMILES: CN(C)c1cccc2c([PH](=O)O)cccc12]

A 1 L round bottom flask is charged with 5-bromo-N,N-dimethylnapthalen-1-amine (23.4 grams, 93.55 mmol, 1.00 equiv) and 277 mL dry tetrahydrofuran. The solution is placed under nitrogen and cooled to −78° C. n-butyllithium (1.6 M in hexane, 61.4 mL, 98.22 mmol, 1.05 equiv) is added dropwise. The mixture is stirred at −78° C. for 30 minutes. Next, bis(diethylamino)chlorophosphine (21.5 mL, 102.9 mmol, 1.10 equiv) is injected. The mixture is allowed to warm to room temperature overnight. The solution is cooled to 0° C. and HCl (2.0 M in diethyl ether, 233.9 mL, 467.8 mmol, 5.00 equiv) is added. The slurry stirred for 2 hours. Nitrogen-sparged water (121 mL, 70.0 equiv) is injected, and the mixture stirred for 2 hours. Two phases are visible. Volatiles are removed by rotary evaporation. The residue is refluxed in 350 mL acetonitrile for one hour. A white solid is removed by hot filtration. The material is purified by reverse-phase chromatography on a C18 column (80:20 MeCN:water) and gives a brown solid. The material still contains diethylammonium chloride and other salts. The residue is boiled in 400 mL acetonitrile overnight, and is filtered. The filtrate contained the undesired impurities and the solid is mostly product with a little diethylammonium chloride. The boiling-filtration sequence is repeated once more, and 20.8 grams of acid is isolated as a white solid (5-(dimethylamino)napthalen-1-yl)phosphinic acid—94% yield).

Characterization of the resultant product is as follows:

¹H NMR (400 MHz, D₂O) δ 8.60 (d, J=8.6 Hz, 1H), 8.18 (d, J=8.7 Hz, 1H), 7.99-7.86 (m, 2H), 7.84 (d, J=541.0 Hz, 1H), 7.82-7.66 (m, 2H), 3.45 (s, 6H).

¹³C NMR (101 MHz, D₂O) δ 137.88, 134.82 (d, J=122.7 Hz), 132.52 (d, J=9.7 Hz), 129.91 (d, J=15.5 Hz), 128.24 (d, J=7.7 Hz), 127.51 (d, J=16.1 Hz), 126.52, 124.55 (d, J=9.3 Hz), 122.74, 118.52, 46.54.

³¹P NMR (162 MHz, D₂O) δ 21.81.

CTAS, which is a comparative example, has the following formula

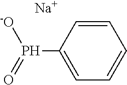

### Preparation of Tagged Treatment Agents

Acrylic Acid monomer with the CTA and Initiator, as shown below in Table 1, are used to prepare the fluorescent-tagged treatment polymers. In particular, deionized water (approximately 60 to 70 grams) and the CTA (approximately 1.2 to 1.7 grams) are added to a 500 ml, 4 necked round bottom glass reactor fitted with a stirrer, a thermocouple, N2 inlet, and a reflux condenser. The contents of the reactor are heated to 92° C. under a nitrogen atmosphere with stirring. A solution of the Initiator (approximately 0.2 grams are dissolved in 1.1 to 1.7 grams of deionized water) is added to the reactor over 100 minutes. Five minutes after the start of the Initiator feed a solution of the CTA (approximately 3.0 to 4.0 grams in 145.0 to 148.0 grams in deionized water) is added to the reactor over 85 minutes.

For examples that use Initiator 1, five minutes after the start of the sodium persulfate feed, 18.7 grams of acrylic acid are added to the reactor over 90 minutes. For examples that use Initiator 2, five minutes after the start of the Vazo™ 56 feed, 18.7 grams of acrylic acid are added to the reactor over 90 minutes. After the feeds are completed the reaction mixture is held at 92° C. for 30 minutes. Then, the reaction mixture is cooled down to 70° C. and 1.9 grams of 50% NaOH in water are added dropwise to the mixture. The neutralization is exothermic, and the rate of NaOH addition is adjusted to keep the reaction temperature below 85° C. The mixture is then cooled to room temperature and collected.

TABLE 1

| | Chain | | | Residual | | | |
|---|---|---|---|---|---|---|---|
| | Transfer | | Solids | Acrylic Acid | M_{w} | Mₙ | |
| | Agent | Initiator | (%) | (ppm) | (kDa) | (kDa) | PDI |
| Comp. A | — | Initiator 1 | 7.8 | 2,157 | 162,575 | 19,179 | 8.5 |
| Comp. B | — | Initiator 2 | 7.5 | 3,749 | 72,055 | 14,487 | 5.0 |
| Ex. 1 | CTA1 | Initiator 1 | 7.1 | 9,800 | 3,925 | 1,845 | 2.1 |
| Ex. 2 | CTA1 | Initiator 2 | 8.8 | 4,870 | 4,389 | 2,046 | 2.1 |
| Ex. 3 | CTA2 | Initiator 2 | 7.5 | 32,381 | 13,300 | 6,037 | 2.2 |
| Ex. 4 | CTA2 | Initiator 2 | 16.5 | 17,790 | 11,245 | 4,389 | 2.6 |
| Comp. C | CTA3 | Initiator 1 | 54.7 | too low to | 3,017 | 1,269 | 2.4 |
| | | | | measure | | | |
| Comp. D | CTA3 | Initiator 2 | 8.8 | 4,870 | 4,389 | 2,046 | 2.2 |

Referring to Table 1, it seen that without use of a chain transfer agent, there is limited control over the final polymer molecular weight of the treatment polymer, as evidenced by the higher than desired PDI of 5 and greater. Also, it is seen that each of CTA1, CTA2, and CTAS are usable as a chain transfer agent to control final polymer molecular weight (e.g., by reducing the average molecular weight/chain length of the resultant polymer during the polymerization process).

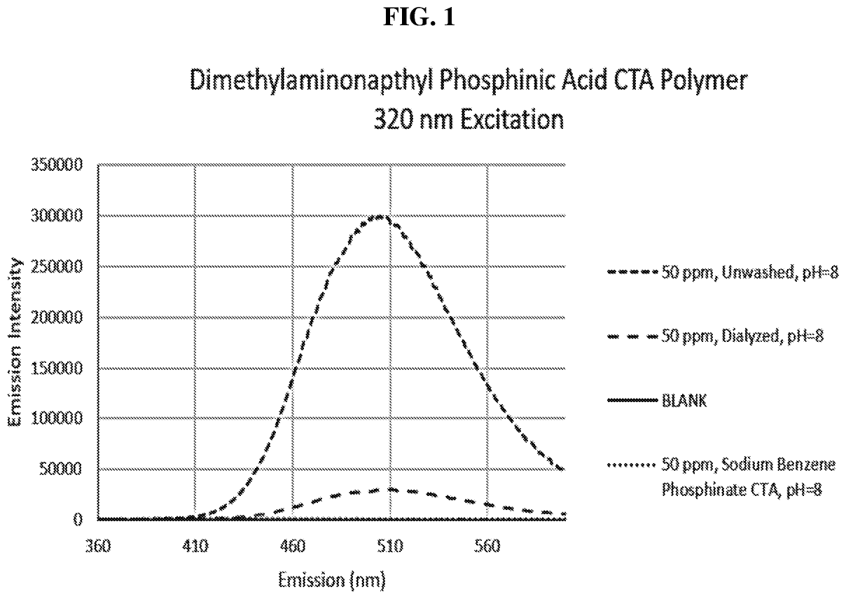

Referring to FIG. 1, the emission intensity of Example 3 (dialyzed and non-dialyzed examples) are evaluated relative to Comparative Example D. For evaluation of the emission intensity, 333 mg of Example 3 is diluted to 500 mL to prepare an ˜50 ppm solution of unwashed/undialyzed polymer. Similarly, samples of dialyzed Example 3 and Comparative Example D are prepared for evaluation. With respect to dialyzed Example 3, 23.1 grams Example 3 is dialyzed in dialysis tubing with a 1 kDa molecular weight cutoff. Three washings are performed on the material and the dialyzed polymer is dried to a solid residue in a vacuum oven, yielding 1.0 grams of solid polymer. Then, 25 mg of the polymer is dissolved in enough water to make a 50 ppm solution (buffered to pH=8). With respect to Comparative Example D, 333 mg of Comparative Example D is diluted to 500 mL to prepare an ˜50 ppm solution.

Fluorescence emission data is collected using a 320 nm excitation wavelength (the pH of the solution is buffered to pH=8), and it seen that the both the dialyzed and non-dialyzed samples of Example 3 have a high emission intensity. This shows that both versions are usable as fluorescent chain transfer agent to prepare fluorescent-tagged treatment polymers. In addition, it is believed FIG. 1 demonstrates that a significant amount of the fluorescent chain transfer agent is incorporated into the treatment polymer, as a high emission intensity is still found in the dialyzed sample. Also, Comparative Example D is shown as not having an emission intensity, such that while CTAS it is useable as a chain transfer agent, it is not additional useable as a fluorescent chain transfer agent to form a fluorescent-tagged treatment polymers. Further, FIG. 1 shows a baseline reading where no fluorescent tagged-treatment polymer is used.

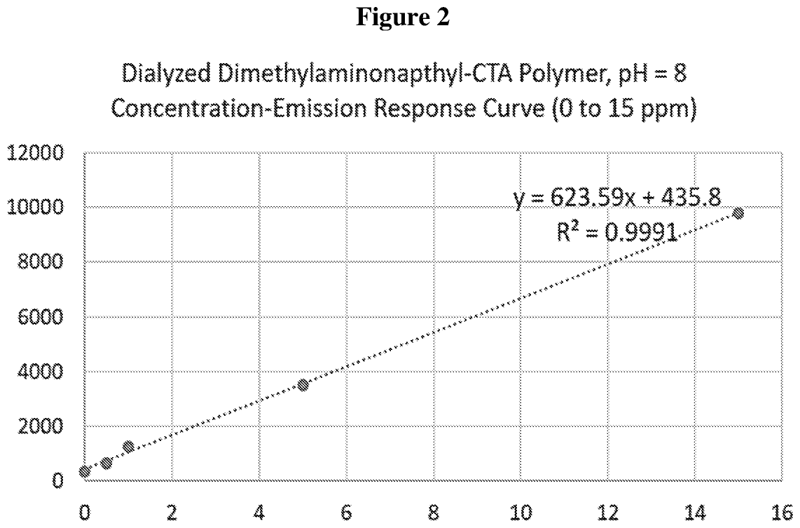

Referring to FIG. 2, a sample of the solid dialyzed polymer of Example 3 is dissolved in enough water to prepare solutions of the following concentrations: 15, 5, 1, 0.5 ppm. All are buffered to pH=8. Fluorescence emission data is collected for each sample, and the emission at 504 nm is plotted as a function of polymer concentration. The concentration/emission response curve is summarized in FIG. 2. In particular, fluorescence emission is observable for polymer solutions with concentrations between 0.5 and 15 ppm. Further, a linear relationship between concentration and emission is observed, which demonstrates that the fluorescent-tagged treatment polymer can be used to quantify concentration and emission response for use in water treatment systems as fluorescent-tagged treatment polymers.

1. A method of treating a water system, the method comprising:
providing to the water system a fluorescent-tagged treatment polymer that is the reaction product of a mixture that includes at least one unsaturated monomer, at least one initiator with at least one reactive terminal group for reacting with the unsaturated monomer, and at least one fluorescent chain transfer agent, the at least one fluorescent chain transfer agent having a phosphorus-hydrogen or sulfur-hydrogen group connected to a polyaromatic hydrocarbon group having from two to ten rings, and the at least one fluorescent chain transfer agent being a chain transfer agent that controls final polymer molecular weight of the fluorescent-tagged treatment polymer and a fluorescent tag for the fluorescent-tagged treatment polymer.

2. The method of claim 1, wherein the one or more fluorescent chain transfer agent is a phosphinic or a thiol based compound.

3. The method of claim 1, wherein the polyaromatic hydrocarbon group has two to five rings.

4. The method of claim 1, wherein at least one of the one or more unsaturated monomer is a monoethylenically unsaturated monomer further having one to five carbonyl groups.

5. The method of claim 1, wherein the fluorescent-tagged treatment polymer is provided in an amount from 0.1 ppm to 100 ppm per liter of water in the water system.

6. The method of claim 1, further comprising preparing the fluorescent-tagged treatment polymer in a reactor by feeding the one or more monomer, the one or more initiator, and the one or more fluorescent chain transfer agent to the reactor.

7. The method of claim 1, further comprising using a fluorimeter to detect a fluorescence signal of the fluorescent-tagged treatment polymer.

8. The method of claim 7, further comprising:
correlating the fluorescence signal from the fluorimeter to a concentration of the fluorescent-tagged treatment polymer in the water system; and
adding an additional amount of the fluorescent-tagged treatment polymer to the water system to adjust the concentration of the fluorescent-tagged treatment polymer in the water system.
